(19) United States
(12) Patent Application Publication
(10) Pub. No.: US 2004/0109932 A1
(43) Pub. Date: Jun. 10, 2004

(54) Flavor coated drinking straw or other article and coating methods therefor

(76) Inventors: You Lung Chen, Altamonte Springs, FL (US); Shengying Zhou, Battle Creek, MI (US); Sevugan Palaniappan, Sugar Land, TX (US)

Correspondence Address: SUTHERLAND ASBILL & BRENNAN LLP, 999 PEACHTREE STREET, N.E., ATLANTA, GA, 30309, US

(21) Appl. No.: 10/696,076

(22) Filed: Oct. 29, 2003

Related U.S. Application Data
(60) Provisional application No. 60/432,137, filed on Dec. 10, 2002.

(51) Int. Cl. A23G 3/00

(52) U.S. Cl. 426/660

(57) ABSTRACT

Methods and coating compositions are provided for producing an acid coated drinking straw or confectionery article. Acid coated drinking straws and acid coated confectionery articles are also provided. The method includes heating a food grade acid composition to a temperature sufficient for the acid composition to become fluid; applying the fluid acid to a surface of a drinking straw or confectionery substrate; and then cooling the acid coated drinking straw or acid coated confectionery substrate to a temperature sufficient to immobilize the acid composition on the surface. The food grade acid composition can comprise, for example, about 40 to 100 weight percent food grade acid (such as citric acid, phosphoric acid, malic acid, or a mixture thereof), 0 to about 5 weight percent surface tension reducing agent, 0 to about 30 weight percent plasticizer, 0 to about 20 weight percent bulk agent, and 0 to about 30 weight percent water.

### CROSS-REFERENCE TO RELATED APPLICATIONS

Priority is claimed to U.S. Provisional Application No. 60/432,137, filed Dec. 10, 2002. That application is incorporated herein by reference.

### BACKGROUND OF THE INVENTION

This invention is generally in the field of drinking straws and more particularly a method of producing a drinking straw that has a flavor component added to one of its surfaces and to compositions of the flavor component.

Manufacturers of beverages are continually pursuing innovative marketing programs to enhance consumer preference for particular products. The use of flavored drinking straws is one such program that has been investigated over the years. While there is no lack of evidence that consumers enjoy flavored drinking straws, the market for these items is limited due to difficulties in manufacturing, packaging, and storing.

Examples of structures that utilize various methods for securing flavoring to the inside of a drinking straw are disclosed in U.S. Pat. No. 5,094,861 to D'Auguste et al. One embodiment is a drinking straw with a powdered flavor layer laminated to the interior surface. In another embodiment, a drinking straw contains spaced inserts of a honeycomb structure that contains the flavoring. PCT WO 99/09871 to Schleider provides a drinking straw having a flavor-producing particulate coating on the outer surface. The coating contains a powdery granular flavor agent and a meltable carrier resin, which is used to adhere the coating to the outer surface of the drinking straw.

### SUMMARY OF THE INVENTION

Methods and coating compositions are provided for producing an acid coated drinking straw or an acid coated confectionery article. Acid coated drinking straws and acid coated confectionery articles are also provided.

In one embodiment, the method includes (a) heating a food grade acid composition to a temperature sufficient for the acid composition to become fluid; (b) applying the fluid acid composition from step (a) to a surface of a drinking straw or confectionery substrate; and (c) cooling the acid composition coated drinking straw or acid coated confectionery substrate from step (b) to a temperature sufficient to immobilize the acid composition on the surface. In various embodiments, the acid composition includes a food grade acid selected from citric acid, adipic acid, fumaric acid, acetic acid, ascorbic acid, gluconolactone, phosphoric acid, hydrochloric acid, sulfuric acid, malic acid, tartaric acid, tannic acid, succinic acid, lactic acid, and mixtures thereof.

In one embodiment, the method further includes, prior to step (a), the step of preparing a food grade acid composition comprising about 40 to about 99.99 weight percent food grade acid, about 0.01 to about 5 weight percent surface tension reducing agent, 0 to about 30 weight percent plasticizer, 0 to about 20 weight percent bulk agent, and 0 to about 30 weight percent water. In one example of this embodiment, the acid composition comprises about 79 to about 99 weight percent food grade acid, about 0.01 to about 1 weight percent surface tension reducing agent, about 0.2 to about 5 weight percent plasticizer, and about 0.79 to about 15 weight percent water. In another example, the acid composition comprises about 88 to about 98 weight percent food grade acid, about 0.01 to about 0.5 weight percent surface tension reducing agent, about 0.2 to about 1 weight percent plasticizer, and about 1.79 to about 10.5 weight percent water. In a preferred embodiment, the acid composition comprises a food grade acid selected from citric acid, phosphoric acid, malic acid, and mixtures thereof. In one embodiment, the surface tension reducing agent is a wetting agent, an emulsifier, or a surfactant. For example, the surface tension reducing agent can be selected from monoglycerides, diglycerides, acetylated monoglycerides, propylene glycol esters, lecithin, diacetyl tartaric acid esters of monoglycerides, glycerol esters, sodium dioctyl sulfosuccinate, polyglycerol esters, polysorbates, sodium stearoyl-2-lactylate, sorbitan esters, sugar esters, and mixtures thereof. In one embodiment, the plasticizer is selected from glycerin, sorbitol, propylene glycol, maltitol, mannitol, and mixtures thereof. In one embodiment, the bulk agent is selected from cellulose fibers, hydrocolloids, low molecular weight carbohydrates, food grade colloidal silicas, and mixtures thereof.

In one embodiment, the acid composition in step (a) includes about 40 to 100 weight percent food grade acid, 0 to about 5 weight percent surface tension reducing agent, 0 to about 30 weight percent plasticizer, 0 to about 20 weight percent bulk agent, and 0 to about 30 weight percent water.

In one embodiment, the application of the fluid acid composition in step (b) occurs by co-extrusion during manufacture of the drinking straw. In another embodiment, the application of the fluid acid composition in step (b) is by spraying the fluid acid composition onto the drinking straw or confectionery substrate. In yet another embodiment, the application of the fluid acid composition in step (b) is by dipping the drinking straw or confectionery substrate into the fluid acid composition or by passing the drinking straw or confectionery substrate through a curtain coater.

In a preferred embodiment, the method steps are applied to a drinking straw. For example, the coating preferably is applied to the interior surface of the drinking straw. In one embodiment, the acid coated drinking straw has an acid dosage loading of about 50 to about 5000 milligrams acid per straw, such as from about 100 to about 1000 milligrams per straw, or from about 200 to about 700 milligrams per straw.

In another embodiment, the method steps are applied to a confectionery substrate. In various embodiments, the confectionery substrate is selected from candies, chewing gums, drink stirrers, spoons, tongue depressors, plastic structures, cereals, popcorn, fruits, and nuts.

In one embodiment, the method further includes applying a secondary coating onto the immobilized acid coating following step (c). For example, the secondary coating can be formed by contacting a powdered ingredient onto the sticky surface of the immobilized acid coating. In various embodiments, the powdered ingredient is selected from additional food acids, sugars, fizzing agents, colorants, probiotics, vitamins, herbs, and flavoring agents.

In a specific embodiment of the methods, a method for producing an acid coated drinking straw includes the steps of (a) preparing a food grade acid composition comprising about 88 to about 98 weight percent food grade acid, about 0.01 to about 0.5 weight percent surface tension reducing agent, about 0.2 to about 1 weight percent plasticizer, and about 1.79 to about 10.5 weight percent water; (b) heating the acid composition to a temperature sufficient for the acid composition to become fluid; (c) applying the fluid acid composition from step (b) to a surface of the drinking straw; and (d) cooling the acid composition coated drinking straw from step (c) to a temperature sufficient to immobilize the acid composition on the surface. In one example, the method yields an acid coated drinking straw having an acid dosage loading of about 50 to about 5000 milligrams of food grade acid per straw. In a preferred embodiment, the food grade acid comprises a mixture comprising two or more of citric acid, phosphoric acid, or malic acid.

In another aspect, a method is provided for forming a self-adherent acid coating on a substrate comprising the steps of (a) heating a composition which comprises a mixture of two or more food grade acids, to form a molten fluid acid mixture; (b) applying a coating of the molten fluid acid mixture from step (a) onto a surface of a solid substrate; and (c) cooling the coated substrate from step (c) to a temperature sufficient to immobilize the acid mixture on the surface of the solid substrate. In one embodiment, the substrate in step (b) is a polymeric tube. In one example of this method, application of the coating in step (b) is by spraying the molten fluid acid mixture onto the interior surface of the tube as the tube is extruded. In another example, the cooling in step (c) occurs by submerging the tube in cooling water. In still another example, during or following step (c), the tube is stretched and cut into drinking straws. In another embodiment, the substrate is selected from candies, chewing gums, drink stirrers, spoons, tongue depressors, plastic structures, cereals, popcorn, fruits, and nuts.

In still another aspect, an acid coated article for imparting flavor to a user is provided. In one embodiment, the article includes a coating carrier comprising a drinking straw or a confectionery substrate; and an immobilized food grade acid composition coated onto a surface of the coating carrier for imparting an acidic flavor, wherein the acid composition coating is formed by heating the acid composition sufficient for the acid composition to become fluid, applying the fluid acid composition to the surface, and then cooling the acid composition sufficiently to immobilize the acid composition on the surface of the coating carrier. In various embodiments of the article, the acid composition comprises an acid selected from the group consisting of citric acid, adipic acid, acetic acid, ascorbic acid, fumaric acid, gluconolactone, phosphoric acid, hydrochloric acid, sulfuric acid, malic acid, tartaric acid, tannic acid, succinic acid, lactic acid, and mixtures thereof.

In a preferred embodiment, the coating carrier is a drinking straw comprising an elongated drinking tube having an interior surface and an exterior surface and formed of a fluid impermeable material. In one embodiment, the drinking straw has an acid dosage loading of about 50 to about 5000 milligrams acid per straw, such as from about 100 to about 1000 milligrams per straw or from about 200 to about 700 milligrams per straw. In a preferred embodiment, the interior surface of the drinking tube is coated with the acid composition.

In one embodiment of the coated article, the acid composition comprises about 40 to about 99.99 weight percent food grade acid, about 0.01 to about 5 weight percent surface tension reducing agent, 0 to about 30 weight percent plasticizer, 0 to about 20 weight percent bulk agent, and 0 to about 30 weight percent water. In a preferred embodiment, the acid composition comprises an acid selected from citric acid, phosphoric acid, malic acid, and mixtures thereof. The surface tension reducing agent can be, for example, a wetting agent, an emulsifier, or a surfactant. In various embodiments, the surface tension reducing agent is selected from monoglycerides, diglycerides, acetylated monoglycerides, propylene glycol esters, lecithin, diacetyl tartaric acid esters of monoglycerides, glycerol esters, sodium dioctyl sulfosuccinate, polyglycerol esters, polysorbates, sodium stearoyl-2-lactylate, sorbitan esters, sugar esters, and mixtures thereof. In various embodiments, the plasticizer is selected from glycerin, sorbitol, propylene glycol, maltitol, mannitol, and mixtures thereof. In various embodiments, the bulk agent is selected from cellulose fibers, hydrocolloids, low molecular weight carbohydrates, food grade colloidal silicas, and mixtures thereof.

In another embodiment of the coated article, the acid composition comprises about 79 to about 99 weight percent food grade acid, about 0.01 to about 1 weight percent surface tension reducing agent, about 0.2 to about 5 weight percent plasticizer, and about 0.79 to about 15 weight percent water.

In yet another embodiment of the coated article, the acid composition comprises about 88 to about 98 weight percent food grade acid, about 0.01 to about 0.5 weight percent surface tension reducing agent, about 0.2 to about 1 weight percent plasticizer, and about 1.79 to about 10.5 weight percent water.

In one embodiment of the coated article, the coating carrier is a confectionery substrate. In various embodiments, the confectionery substrate is selected from candies, chewing gums, drink stirrers, spoons, tongue depressors, plastic structures, cereals, popcorn, fruits, and nuts.

In one embodiment, the coated article further includes a secondary coating which is coated onto the food acid composition coating. In one example, the secondary coating comprises a powdered ingredient adhered onto the surface of the food acid composition coating. For instance, the powdered ingredient can be selected from food acids, sugars, fizzing agents, colorants, probiotics, vitamins, herbs, and flavoring agents.

In one embodiment, an acid coated drinking straw is provided which includes an elongated drinking tube having an interior surface and an exterior surface and formed of a fluid impermeable material; and a food grade acid composition coated on at least one of the surfaces for imparting an acidic flavor, wherein the acid composition comprises about 88 to about 98 weight percent food grade acid, about 0.01 to about 0.5 weight percent surface tension reducing agent, about 0.2 to about 1 weight percent plasticizer, and about 1.79 to about 10.5 weight percent water. In one variation of this drinking straw, the acid composition coating is applied by heating an acid composition to a temperature sufficient for the acid composition to be fluid, applying the fluid acid composition onto the at least one of the surfaces, and then cooling the composition to immobilize the acid composition on the at least one of the surfaces, thereby forming the coating which self-adheres to the at least one of the surface of the drinking straw. In one example, the acid dosage loading is about 50 to about 5000 milligrams acid per straw. In a preferred embodiment, the food grade acid comprises a mixture comprising two or more of citric acid, phosphoric acid, or malic acid.

In one specific embodiment, an acid coated drinking straw is provided, which includes an elongated drinking tube having an interior surface and formed of a fluid impermeable material; and a food grade acid composition coated on the interior surface, wherein the acid composition comprises about 88 to about 98 weight percent food grade acid selected from the group consisting of citric acid, adipic acid, acetic acid, ascorbic acid, fumaric acid, gluconolactone, phosphoric acid, hydrochloric acid, sulfuric acid, malic acid, tartaric acid, tannic acid, succinic acid, lactic acid and mixtures thereof; about 0.01 to about 0.5 weight percent surface tension reducing agent selected from the group consisting of monoglycerides, diglycerides, acetylated monoglycerides, propylene glycol esters, lecithin, diacetyl tartaric acid esters of monoglycerides, glycerol esters, sodium dioctyl sulfosuccinate, polyglycerol esters, polysorbates, sodium stearoyl-2-lactylate, sorbitan esters, sugar esters and mixtures thereof; about 0.2 to about 1 weight percent plasticizer selected from the group consisting of glycerin, sorbitol, propylene glycol, maltitol, mannitol and mixtures thereof; and about 1.79 to about 10.5 weight percent water. In a preferred example, the food grade acid is selected from citric acid, phosphoric acid, malic acid and mixtures thereof; the surface tension reducing agent is monoglyceride; and the plasticizer is glycerin. Preferably, the acid coated drinking straw has an acid dosage loading of about 50 to about 5000 milligrams acid per straw.

In another aspect, a beverage kit is provided which includes a container comprising beverage; and at least one acid coated drinking straw suitable for insertion into the container and for imparting an acid flavor to the beverage when drinking the beverage through the straw, wherein the drinking straw comprises a food grade acid composition coated on the interior surface of the drinking straw. In one embodiment, the beverage comprises a fruit juice or fruit drink.

### DESCRIPTION OF THE INVENTION

Coating methods and compositions have been developed for use in producing an acid coated drinking straw or other acid coated article for imparting an acidic or sour taste. The coating composition comprises a high concentration of one or more food grade acids and advantageously can self-adhere to the surface of the drinking straw or other substrate absent an adhesive agent. In contrast, conventional coating compositions utilized granular flavor particulates suspended in a carrier adhesive agent, resulting in less flavor imparted to the consumer or were heavily loaded with water for fluidity, thus making immobilization difficult without excessive evaporation procedures.

As used herein, the terms “comprise,” “comprising,” “include,” and “including” are intended to be open, non-limiting terms, unless the contrary is expressly indicated

The Acid Coating Composition

The food grade acid composition (“acid composition”) may include or consist of any food grade acid that provides the processing characteristics discussed herein. Examples of suitable food grade acids include citric acid, adipic acid, acetic acid, ascorbic acid, fumaric acid, gluconolactone, phosphoric acid, hydrochloric acid, sulfuric acid, malic acid, tartaric acid, tannic acid, succinic acid, lactic acid, and mixtures thereof. In preferred embodiments, the food grade acid is citric acid, phosphoric acid, malic acid, or a mixture thereof. In one embodiment, the coating composition comprises a mixture of two or more of citric acid, phosphoric acid, and malic acid. For embodiments where the surface of the drinking straw and the acid composition are compatible, the food grade acid may be the only component of the acid composition.

In one embodiment, the acid composition includes multiple components and is prepared prior to heating. The fluidized acid composition may be in the form of a solution, slurry, or emulsion depending on the components. The components in combination need to produce a fluid acid composition when heated to a particular temperature, which is below the melting temperature of the substrate, such as the fluid impermeable material used in forming the drinking straw. In one embodiment, the fluidized acid composition has a viscosity of less than about 2000 centipoises. After application to the surface of the substrate, the multi-component acid composition needs to cool rapidly to immobilize, forming the acid coating. In one embodiment, the acid composition meeting these requirements comprises about 40 to about 99.99 weight percent food grade acid, about 0.01 to about 5 weight percent surface tension reducing agent, 0 to about 30 weight percent plasticizer, 0 to about 20 weight percent bulk agent, and 0 to about 30 weight percent water. In another embodiment, the acid composition comprises about 79 to about 99 weight percent food grade acid, about 0.01 to about 1 weight percent surface tension reducing agent, about 0.2 to about 5 weight percent plasticizer, and about 0.79 to about 15 weight percent water. In yet another embodiment, the acid composition comprises about 88 to about 98 weight percent food grade acid, about 0.01 to about 0.5 weight percent surface tension reducing agent, about 0.2 to about 1 weight percent plasticizer, and about 1.79 to about 10.5 weight percent water.

These multi-component embodiments are particularly useful for coating commercially available drinking straws made of fluid impermeable materials, such as wax coated paper or plastics, including polypropylene and polyethylene. While the surfaces of these impermeable materials are often incompatible with a food acid composition, causing difficulty in their application, the use of a surface tension reducing agent was found to result in the acid composition more readily spreading along the surface of the drinking straw during the application step. Preferably, the surface reducing agent is a wetting agent, an emulsifier or a surfactant. Useful examples include monoglycerides, diglycerides, acetylated monoglycerides, propylene glycol esters, lecithin, diacetyl tartaric acid esters of monoglycerides, glycerol esters, sodium dioctyl sulfosuccinate, polyglycerol esters, polysorbates, sodium stearoyl-2-lactylate, sorbitan esters, sugar esters and mixtures thereof. In a preferred embodiment, the surface tension reducing agent includes monoglyceride.

The plasticizer is used to increase the flexibility of the coating, thereby preventing cracking after cooling and prior to use. Examples of suitable plasticizers include glycerin, sorbitol, propylene glycol, maltitol, mannitol, and mixtures thereof. In a preferred embodiment, the plasticizer comprises glycerin.

The optional bulk agent is utilized primarily as a filler. It can be useful, for example, when producing large diameter acid coated drinking straws. Examples of suitable bulk agents include cellulose fibers (such as alpha cellulose fiber available as AviCel from FMC Biopolymer of Philadelphia, Pa.), hydrocolloids (such as guar and gum arabic), low molecular weight carbohydrates (such as corn syrups and maltodextrins), food grade colloidal silicas, and mixtures thereof.

Water may be added to the acid composition for increased fluidity during the coating process. If added, however, the water desirably is added in limited amounts in order to minimize the amount of subsequent processing energy needed (e.g., for cooling and/or evaporating the added water). In one embodiment, water is present from 0 to about 30 weight percent, preferably from 0.79 to about 15 weight percent, and more preferably from 1.79 to about 10.5 weight percent.

While the above compositions are specifically suited to the coating of polymeric drinking straws, the proportions or components may be modified for coating other substrate shapes or materials. For example, the food grade acid composition can comprise about 40 to 100 weight percent food grade acid, 0 to about 5 weight percent surface tension reducing agent, 0 to about 30 weight percent plasticizer, 0 to about 20 weight percent bulk agent, and 0 to about 30 weight percent water. In one embodiment, the composition comprises 100% food acid, which can be a single food acid or a mixture of two or more food acids.

The Acid Coating Methods

Methods are provided for coating articles with the acid compositions described herein. In one embodiment, the method for producing an acid coated drinking straw or an acid coated confectionery article comprising the steps of:

(a) heating a food grade acid composition to a temperature sufficient for the acid composition to be fluid;

(b) applying the fluid acid composition from step (a) to a surface of the drinking straw or of the confectionery substrate; and

(c) cooling the acid coated drinking straw or acid coated confectionery substrate from step (b) to a temperature sufficient to immobilize the acid composition on the surface.

Various techniques can be used to apply the fluid acid composition. In one embodiment, application of the fluid acid composition occurs by co-extrusion during manufacture of the drinking straw. In another embodiment, application of the fluid acid composition is by spraying the fluid acid composition onto the drinking straw or confectionery substrate. In still another embodiment, application of the fluid acid composition is by dipping the drinking straw or confectionery substrate into the fluid acid composition. In yet a further embodiment, the drinking straw or confectionery substrate is passed through a curtain coater, wherein the article to be coated passes through a flowing sheet (i.e., a curtain) of the fluid composition which flows over a weir and falls downward due to gravitational force. The article is coated as it passes through this sheet. Conventional coating equipment can be used or adapted for dipping, spraying, or curtain coating the drinking straws and confectionery substrates with the fluid acid compositions described herein.

In a preferred embodiment, the acid composition can be prepared and applied to the interior and/or exterior surfaces of the drinking straw. Preferably, the acid composition is applied to the interior surface of the drinking straw. Various application methods include co-extrusion of the fluid acid composition during straw production, spraying/applying/injecting the fluid acid composition onto the interior surface of the straw during straw production, dipping the straw in the fluid acid composition, and pumping the fluid acid composition through the straw. Several preferred methods of application are disclosed in U.S. Patent Application Publication No. 2003/0168772 entitled “Method and Apparatus for Coating the Interior Surface of a Straw.”

In one specific embodiment of making an acid coated straw, the method comprises the steps of:

(a) preparing a food grade acid composition comprising about 88 to about 98 weight percent food grade acid, about 0.01 to about 0.5 weight percent surface tension reducing agent, about 0.2 to about 1 weight percent plasticizer, and about 1.79 to about 10.5 weight percent water;

(b) heating the acid composition to a temperature sufficient for the acid composition to be fluid;

(c) applying the fluid acid composition from step (b) to a surface of the drinking straw; and

(d) cooling the acid coated drinking straw from step (c) to a temperature sufficient to immobilize the acid composition on the surface. In preferred variations of this method, the food grade acid comprises a mixture comprising two or more of citric acid, phosphoric acid, or malic acid, and the acid dosage loading per straw is from about 50 to about 5000 milligrams. The coating can be applied to all or part of the exterior surface, the interior surface or both the interior and exterior surfaces.

In another aspect, a method is provided for forming a self-adherent acid coating on a substrate comprising the steps of:

(a) heating a composition which comprises a mixture of two or more acids, to form a molten fluid acid mixture;

(b) applying a coating of the molten fluid acid mixture from step (a) onto a surface of a solid substrate; and

(c) cooling the coated substrate from step (c) to a temperature sufficient to immobilize the acid mixture on the surface of the solid substrate.

In one embodiment, the substrate is a polymeric tube. In one specific method, application of the coating is by spraying the molten fluid acid mixture onto the interior surface of the tube as the tube is extruded. In one specific method, cooling occurs by submerging the tube in cooling water. Air cooling could also be used. In one embodiment, during or following step (c), the tube is stretched and cut into drinking straws, which can be subsequently packaged.

In another embodiment, the substrate is selected a confectionery substrate. For example, the substrate could be selected from candies, chewing gums, drink stirrers, spoons, tongue depressors, plastic structures, cereals, popcorn, fruits, or nuts.

In still another embodiment of the coating methods described herein, a secondary coating is applied onto, or over, at least part of the immobilized acid coating. In one approach, a secondary coating is formed by contacting a powdered ingredient onto the surface of the immobilized acid coating, which initially can be very sticky. Examples of suitable powdered ingredients include food acids, sugars, colorants, fizzing agents (e.g., sodium bicarbonate), probiotics, vitamins, herbs, or other flavoring agents, which can enhance the sour taste or nutritional value, or create a unique flavor/acid combination. In one embodiment, the powdered ingredients are passed (e.g., blown in a dispersion in air or another gas) through the acid coated drinking straw, where particles adhere to the sticky acid coating.

While not generally preferred for the coating plastic drinking straws, an alternative coating method for use with some of the coating compositions described herein includes application of the coating composition onto the confectionery substrate or straw, wherein the fluid coating composition includes food acid(s) dissolved or dispersed in a volatile solvent (e.g., water) at ambient temperatures followed by evaporation of the volatile solvent to immobilize the composition on the substrate or straw. In such as process, it would not be necessary to heat and cool to achieve fluidization and immobilization, respectively, of the coating composition.

The Acid Coated Drinking Straws and Other Acid Coated Articles

In another aspect, acid coated articles for imparting flavor are provided. In preferred embodiments, the article includes a coating carrier comprising a drinking straw or a confectionery substrate; and an immobilized food grade acid composition coated onto a surface of the coating carrier for imparting an acidic flavor. The coating carrier can be for example, a drinking straw or portion thereof, or a confectionery substrate.

In one embodiment, the coating carrier is drinking straw comprising an elongated drinking tube having an interior surface and an exterior surface and formed of a fluid impermeable material. For example, the article can be an acid coated drinking straw having a food grade acid composition coated on one of the surfaces (e.g., the interior) for imparting an acidic flavor. All preferred embodiments of the food grade acid compositions set forth above typically would apply to the article embodiments as well.

In still another embodiment, an acid coated drinking straw is provided which comprises an elongated drinking tube having an interior surface and an exterior surface and formed of a fluid impermeable material and a food grade acid composition coated on one of the surfaces for imparting an acidic flavor, wherein the acid composition comprises about 88 to about 98 weight percent food grade acid, about 0.01 to about 0.5 weight percent surface tension reducing agent, about 0.2 to about 1 weight percent plasticizer, and about 1.79 to about 10.5 weight percent water; and self-adheres to the surface of the drinking straw absent an adhesive agent.

In yet another embodiment, an acid coated drinking straw is provided which comprises an elongated drinking tube having an interior surface and formed of a fluid impermeable material and a food grade acid composition coated on the interior surface absent an adhesive agent, wherein the acid composition comprises about 88 to about 98 weight percent food grade acid selected from the group consisting of citric acid, adipic acid, acetic acid, ascorbic acid, fumaric acid, gluconolactone, phosphoric acid, hydrochloric acid, sulfuric acid, malic acid, tartaric acid, tannic acid, succinic acid, lactic acid, and mixtures thereof; about 0.01 to about 0.5 weight percent surface tension reducing agent selected from the group consisting of monoglycerides, diglycerides, acetylated monoglycerides, propylene glycol esters, lecithin, diacetyl tartaric acid esters of monoglycerides, glycerol esters, sodium dioctyl sulfosuccinate, polyglycerol esters, polysorbates, sodium stearoyl-2-lactylate, sorbitan esters, sugar esters and mixtures thereof; about 0.2 to about 1 weight percent plasticizer selected from the group consisting of glycerin, sorbitol, propylene glycol, maltitol, mannitol, and mixtures thereof; and about 1.79 to about 10.5 weight percent water.

For the consumer to receive an adequate acidic flavor for an acceptable time period with the acid coated drinking straw, the food grade acid composition is present in an acid dosage loading per straw of about 50 to about 5000 milligrams, preferably about 100 to about 1000 milligrams, and more preferably from about 200 to about 700 milligrams. The acid dosage loading for the food grade acid composition is the amount of acid component, i.e., food grade acid, in milligrams coated on each straw.

Preferably, the coating composition on the drinking straw comprises a mixture of two or more of the food acids, as it is believed that the mixture reduces the coating chipping or flaking off of the straw, relative to use of a single acid composition. In one embodiment, it is desirable for the coating to remain substantially adhered to the straws for an extended period of time following coating of the composition onto the straw. For example, it may be desirable for the product shelf life to be at least about 60 days, 180 days, or about one year or more.

The acid coated drinking straw can be further processed and packaged for future use. For example, the straws can be wrapped individually or in groups, and/or packaged for sale individually or in groups. Alternatively, one or more straws can be packaged together with a packaged beverage. For example, the acid coated drinking straws can be attached to a single serving beverage container, such as an aluminum can, a glass or plastic bottle, carton, pouch, or juice box.

In another embodiment of the article, the coating carrier comprises a confectionery substrate. As used herein, the term “confectionery substrate” refers to any edible or non-edible structure, other than a drinking straw, that is compatible with the acid compositions described herein and which can be used as a storage and transfer medium for the acid composition coating, that is, useful in effecting the flavor addition. Examples of edible confectionery substrates include candies (e.g., lollipops), chewing gums, popcorn, nuts, cereals, and fruits (fresh or dehydrated). Examples of non-edible confectionery substrates include drink stirrers (e.g., wooden or plastic sticks or tubes), spoons, tongue depressors, garnish skewers (e.g., for olives, fruit in bar drinks), and other plastic structures (e.g., made of polyethylene, polypropylene, polyethylene terephthalate, or polyethylene naphthalate), for example, which can be incorporated into novelty or interactive candies, which may be of particular interest to children. In various embodiment, the plastic structure is a bottle.

Because the coated acid composition can be initially very sticky, other powdered ingredients, such as acid, sugar, colorants, fizzing agents, probiotics, herbs, vitamins, or flavoring agents, can also be used to pass or blow through the acid coated carrier to form additional coating(s) to enhance sour taste, nutrition value, or unique flavor/acid combination of the acid coated carrier.

Use of the Acid Coated Straws or Other Acid Coated Articles

The acid coated drinking straw is intended to be used with beverages such as juices, juice drinks, water, dairy products, carbonated and non-carbonated soft drinks, alcoholic and non-alcoholic drinks, and sports drinks, where the impact of an acidic or sour taste is desirable. During the drinking or sipping of beverage through the acid coated drinking straw, the coated acid composition will dissolve into the passing liquid and impart a sour or acidic taste to the consumer. Dissolution rate of the coated acid composition, duration of acid tastes, and acid concentration/intensity of the passing liquid are dependent upon acid composition, beverage flavors, pH, temperature, liquid flow rate, straw material/dimension/design, coating surface area, uniformity, weight, and thickness.

Use of the various acid coated confectionery articles depends on the particular article. For example, the acid coating can be consumed directly from the substrate (e.g., acid coated tongue depressor, lollipop, gum, hard candy), can be consumed with the substrate (e.g., acid coated candy, popcorn, nuts), or the coating can be allowed to dissolve off of the substrate into a beverage or food (e.g., acid coated drink stirrer, spoon, garnish skewer, etc.).

The methods and compositions described above will be further understood with reference to the following non-limiting examples.

### EXAMPLE 1

### Coating Straws with Citric Acid Composition

Drinking straws were coated with a citric acid composition. A coating solution was prepared having the following formulation:

| Material | Weight (g) | Percentage (%) |
|---|---|---|
| Citric acid anhydrous | 3620 g | 90.5% |
| Deionized (DI) water | 352 g | 8.8% |
| Glycerin (USP grade) | 20 g | 0.5% |
| Monoglyceride | 8 g | 0.2% |
| Total | 4000 g | 100.0% |

A 4 kg batch of molten citric acid solution was prepared. First, 352 g of DI water and 1800 g of citric acid anhydrous were added to a 3 L stainless steel (“SS”) beaker, which was placed on the top of a hot plate. The citric acid slurry, while mixing with a tri-blade mixer, was heated to approximately 110° C. When the temperature of the citric acid slurry reached about 110° C., the remaining citric acid solids, 1820 g, were slowly added to the slurry. This concentrated citric acid slurry completely hydrated at about 125 to 130° C., and the solution became transparent. Then, 20 g of glycerin and 8 g of monoglyceride were added to the clear citric acid solution. Because monoglyceride does not completely dissolve in the citric acid solution, proper agitation was needed to ensure its uniform distribution in the solution.

Next, the coated straws were made. One hundred straws with dimension of 15.9 cm in length and 0.4 cm in diameter were used to prepare citric acid coated straws. A virgin straw was held by forceps and slowly dipped into the acid solution for several seconds. The acid coated straw was then removed from the acid solution. Because the citric acid solution bath was maintained at about 130° C., the coated citric acid solution on the straw was initially very hot and sticky. To control the coating weight of the straw, the excess coated acid solution was allowed to drip off and the coated straw was purged with nitrogen gas for several seconds to quickly cool the temperature, from very hot to warm, of the acid solution inside the straw. Hence, the warm citric acid coating quickly increased in viscosity and formed an immobile transparent and sticky coating. These acid coated straws were stored at room temperature for about two hours and then transferred to a plastic bag for storage. After the coating step, the coated straws were cooled. As it cooled to room temperature, the coating on the straws was observed to undergo a gradual transformation from a transparent structure to an opaque structure of citric acid and citric acid monohydrate. After overnight storage, the citric acid coating on the outside of the straws was removed to yield coated straws for evaluation. The acid dosage loading per straw ranged from 150 to 650 milligrams.

The coated straws were then tested. A six-person taste panel was formed to evaluate the taste impact of the acid straws on the juice drinks of different flavors. The flavors evaluated were Fruit Punch, Clear Cherry, Apple Drink and Juice, and Berry Punch. Conclusions from the taste panel were that an initial sour taste enhancement was observed through first several sips of juice drinks, the sour intensity peaked around the second to the third sips for most of the juice drinks, the sour impact tended to last seven to ten sips of juice drinks, and the juice drink compositions and flavors played key roles in determining the detail taste impact of the acid straws. In general, the punch fruit flavors were found to go well with the acid straws.

### EXAMPLE 2

### Coating Straws with Citric Acid and 7.5% Phosphoric Acid Composition

Drinking straws were coated with a citric acid and phosphoric acid composition. A coating solution was prepared having the following formulation:

| Materials | Weight (g) | Percentage (%) |
|---|---|---|
| Citric acid anhydrous | 3272 g | 81.8% |
| Phosphoric acid (75 wt %) | 400 g | 10.0% |
| DI water | 300 g | 7.5% |
| Glycerin (USP grade) | 20 g | 0.5% |
| Monoglyceride | 8 g | 0.2% |
| Total | 4000 g | 100.0% |

A 4 kg batch of molten mixed acid solution was prepared. First, 300 g of DI water and 1700 g of citric acid anhydrous were added to a 3 L SS beaker, which was placed on the top of a hot plate. The citric acid slurry, while mixing with a tri-blade mixer, was heated to about 110° C. When the temperature of the citric acid slurry reached 110° C., the remaining citric acid solids, 1572 g, were then slowly added to the slurry. When the temperature of the citric acid slurry reached about 125° C., the remaining 75 wt % phosphoric acid solution, 400 g, was then slowly added to the slurry. This concentrated citric/phosphoric acid slurry became transparent at about 125° C. Then, 20 g of glycerin and 8 g of monoglyceride were added to the clear acid solution. Agitation was used to ensure uniform distribution of the monoglyceride in the solution.

Next, the coated straws were made. One hundred straws with dimension of 15.9 cm in length and 0.4 cm in diameter were used to prepare citric/phosphoric acid coated straws. Using the same dip coating, cooling, drying, and outer surface removal steps as described in Example 1, the straws were provided with an opaque interior coating citric acid/phosphoric acid monohydrate. The acid dosage loading per straw ranged from 150 to 600 milligrams.

The coated straws were then tested. An eight-person taste panel evaluated the effect of acid coated straws on juice drinks. The flavors tested were sour apple, strawberry, and tropical. In general, the straws introduced an intense sour taste to the products for the first few sips. The maximum intensity was obtained around two to five sips, and the sour taste lasted for about ten sips. However, the impact was different depending on the flavor of the drink.

### EXAMPLE 3

### Coating Straws with Citric Acid and 3.75% Phosphoric Acid Composition

Drinking straws were coated with a citric acid and phosphoric acid composition. A coating solution was prepared having the following formulation:

| Materials | Weight (g) | Percentage (%) |
|---|---|---|
| Citric acid anhydrous | 3440 g | 86.0% |
| Phosphoric acid (75 wt %) | 200 g | 5.0% |
| DI water | 332 g | 8.3% |
| Glycerin (USP grade) | 20 g | 0.5% |
| Monoglyceride | 8 g | 0.2% |
| Total | 4000 g | 100.0% |

A 4 kg batch of molten mixed acid solution was prepared. First, 332 g of DI water and 1700 g of citric acid anhydrous were added to a 3 L SS beaker, which was placed on the top of a hot plate. The citric acid slurry, while mixing with a tri-blade mixer, was heated to about 110° C. When the temperature of the citric acid slurry reached 110° C., the remaining citric acid solids, 1740 g, were then slowly added to the slurry. When the temperature of the citric acid slurry reached about 125° C., the remaining 75 wt % phosphoric acid solution, 200 g, was then slowly added to the slurry. This concentrated citric/phosphoric acid slurry became transparent at about 125° C. Then, 20 g of glycerin and 8 g of monoglyceride were added to the clear acid solution. Agitation was used to ensure uniform distribution of the monoglyceride in the solution.

Next, the coated straws were made. One hundred straws with dimension of 15.9 cm in length and 0.4 cm in diameter were used to prepare citric/phosphoric acid coated straws. Using the same dip coating, cooling, drying, and outer surface removal steps as described in Example 1, the straws were provided with an opaque interior coating citric acid/phosphoric acid monohydrate. The acid dosage loading per straw ranged from 150 to 600 milligrams.

A six-person panel evaluated the effect of citric/phosphoric acid coated straws on juice drinks. The flavor tested was fruit punch. In general, the straws introduced an intense sour taste to the products for the first few sips. The maximum intensity was obtained around two to five sips, and the sour taste lasted for about seven to ten sips.

### EXAMPLE 4

### Coating Straws with Citric Acid Composition Using Commercial Straw Extruder

Drinking straws were coated with a citric acid composition. A coating solution was prepared having the following formulation:

| Materials | Weight (g) | Percentage (%) |
|---|---|---|
| Citric acid anhydrous | 15100 g | 90.5% |
| DI water | 1470 g | 8.8% |
| Glycerin (USP grade) | 84 g | 0.5% |
| Monoglyceride | 33 g | 0.2% |
| Total | 16687 g | 100.0% |

A 16.7 kg batch of molten citric acid solution was prepared. First, 1470 g of DI water and 8000 g of citric acid anhydrous were added to a 5 gallon SS container, which was placed on top of a hot plate. The citric acid slurry, while mixing with a paddle mixer, was heated to about 110° C. When the temperature of the citric acid slurry reached about 110° C., the remaining citric acid solids, 7100 g, were slowly added to the slurry. This concentrated citric acid slurry completely hydrated at about 125 to 130° C., and the solution became transparent. Then, 84 g of glycerin and 33 g of monoglyceride were added to the clear citric acid solution. Agitation was used to ensure uniform distribution of the monoglyceride in the solution.

Next, coated straws were made using a commercial straw extruder, manufactured by Norel (Sweden, model NX75-25D-50L), modified with a novel extrusion head and nozzle, which is described in U.S. Patent Application Publication No. 2003/0168772 by Palaniappan, et al. The molten citric acid solution at about 125° C. was then pumped, using a precision gear pump, to the modified continuous straw extrusion head and nozzle with an acid solution flow rate of about 200 g/min. and an air flow rate of about 4 L/min. When the flow rate of the acid solution reached steady state, production of the acid coated straw was initiated. After about ten minutes of continuous processing, a production rate of about 80,000 straws (based on the average straw length of 15.9 cm) per hour of the acid coated straw was achieved. The acid dosage loading per straw ranged from 300 to 900 milligrams. Approximately one kilometer of the acid coated straw was produced, which could then be further processed and package for use with beverages.

### EXAMPLE 5

### Coating Straw with Citric Acid and 20% Phosphoric Acid Composition

Drinking straws were coated with a citric acid and phosphoric acid composition. A coating solution was prepared having the following formulation:

| Materials | Weight (g) | Percentage (%) |
|---|---|---|
| Citric acid anhydrous | 2704 g | 72.5% |
| Phosphoric acid (75 wt %) | 1067 g | 26.7% |
| Glycerin (USP grade) | 20 g | 0.5% |
| Monoglyceride | 12 g | 0.3% |
| Total | 4000 g | 100.0% |

A 4 kg batch of molten mixed acid solution was prepared. First, 1067 g of phosphoric acid (75 wt %) and 1500 g of citric acid anhydrous were added to a 3 L SS beaker, which was placed on the top of a hot plate. The citric/phosphoric acid slurry, while mixing with a tri-blade mixer, was heated to about 110° C. When the temperature of the citric/phosphoric acid slurry reached about 110° C., the remaining citric acid solids, 1204 g, were then slowly added to the slurry. When the temperature of the slurry reached about 130° C., 20 g of glycerin and 8 g of monoglyceride were then added to the acid solution. Agitation was used to ensure uniform distribution of the monoglyceride in the solution.

Next, the coated straws were made. One hundred straws with dimension of 15.9 cm in length and 0.4 cm in diameter were used to prepare citric/phosphoric acid coated straws. Using the same dip coating, cooling, drying, and outer surface removal steps as described in Example 1, the straws were provided with an opaque interior coating citric acid/phosphoric acid monohydrate. The acid dosage loading per straw ranged from 150 to 600 milligrams.

A six-person panel evaluated the effect of citric/phosphoric acid coated straws on juice drinks. The flavor tested was fruit punch. In general, the straws introduced an intense sour taste to the products for the first few sips. The maximum intensity was obtained around two to five sips, and the sour taste lasted for about seven to ten sips.

### EXAMPLE 6

### Coating Straw with Citric Acid and 25% Malic Acid Composition

Drinking straws were coated with a citric acid and malic acid composition. A coating solution was prepared having the following formulation:

| Materials | Weight (g) | Percentage (%) |
|---|---|---|
| Citric acid anhydrous | 2714 g | 67.9% |
| Malic acid anhydrous | 1000 g | 25.0% |
| DI water | 262 g | 6.5% |
| Glycerin (USP grade) | 20 g | 0.5% |
| Monoglyceride | 4 g | 0.1% |
| Total | 4000 g | 100.0% |

A 4 kg batch of molten mixed acid solution was prepared. First, 262 g of DI water and 1500 g of citric acid anhydrous were added to a 3 L SS beaker, which was placed on the top of a hot plate. The citric acid slurry, while mixing with a tri-blade mixer, was heated to about 110° C. When the temperature of the citric acid slurry reached about 110° C., the remaining solids of citric acid and malic acid, 2214 g, were then slowly added to the slurry. When the temperature of the slurry reached about 120° C., 20 g of glycerin and 8 g of monoglyceride were then added to the acid solution. Agitation was used to ensure uniform distribution of the monoglyceride in the solution.

Next, the coated straws were made. One hundred straws with dimension of 15.9 cm in length and 0.4 cm in diameter were used to prepare citric/malic acid coated straws. Using the dip coating (at 115° C.), cooling, drying, and outer surface removal steps described in Example 1, the straws were provided with an opaque interior coating citric acid/malic acid. The acid dosage loading per straw ranged from 150 to 650 milligrams.

### EXAMPLE 7

### Coating Straws with Malic Acid Composition

Drinking straws were coated with a malic acid composition. A coating solution was prepared having the following formulation:

| Material | Weight (g) | Percentage (%) |
|---|---|---|
| Malic acid anhydrous | 3852 g | 96.3% |
| Deionized (DI) water | 120 g | 3.0% |
| Glycerin (USP grade) | 20 g | 0.5% |
| Monoglyceride | 8 g | 0.2% |
| Total | 4000 g | 100.0% |

A 4 kg batch of molten malic acid solution was prepared. First, 120 g of DI water and 250 g of malic acid anhydrous were added to a 3 L SS beaker, which was placed on the top of a hot plate. The malic acid slurry, while mixing with a tri-blade mixer, was heated to about 110° C. When the temperature of the malic acid slurry reached about 110° C., the remaining malic acid solids, 3602 g, were slowly added to the slurry. This concentrated malic acid slurry completely hydrated at about 115° C. and the solution became transparent. Then, 20 g of glycerin and 8 g of monoglyceride were added to the clear malic acid solution. Agitation was used to ensure uniform distribution of the monoglyceride in the solution.

Next, the coated straws were made. One hundred straws with dimension of 15.9 cm in length and 0.4 cm in diameter were used to prepare malic acid coated straws. Using the dip coating (at 115° C.), cooling, drying, and outer surface removal steps described in Example 1, the straws were provided with an opaque interior coating of malic acid. The acid dosage loading per straw ranged from 150 to 650 milligrams.

A six-person taste panel was formed to evaluate the taste impact of the acid straws on the juice drinks of different flavors. The flavors evaluated were Fruit Punch, Clear Cherry, Apple Drink and Juice, and Berry Punch. Conclusions from the taste panel were that an initial sour taste enhancement was observed through first several sips of juice drinks, the sour intensity peaked around the second to the third sips for most of the juice drinks, the sour impact tended to last seven to ten sips of juice drinks, and the juice drink compositions and flavors played key roles in determining the detail taste impact of the acid straws. In general, the punch fruit flavors were found to go well with the acid straws.

### EXAMPLE 8

### Coating Straws with Malic Acid and Citric Acid Composition Using Commercial Straw Extruder

Drinking straws were coated with a malic acid and citric acid mixture composition. A coating solution was prepared having the following formulation:

| Materials | Weight (g) | Percentage (%) |
|---|---|---|
| Malic acid anhydrous | 21420 g | 71.4% |
| Citric acid anhydrous | 7140 g | 23.8% |
| DI water | 1200 g | 4.0% |
| Glycerin (USP grade) | 150 g | 0.5% |
| Monoglyceride | 90 g | 0.3% |
| Total | 30000 g | 100.0% |

A 30 kg batch of molten malic acid and citric acid solution was prepared. First, 1200 g of DI water and 4000 g of citric acid anhydrous were added to a 5 gallon SS container, which was placed on top of a hot plate. The citric acid slurry, while mixing with a paddle mixer, was heated to about 100° C. When the temperature of the citric acid solution reached about 100° C., the remaining citric acid solids, 3140 g, were slowly added to the solution. When the temperature of the citric acid slurry reached about 100° C., the malic acid, 21420 g, were slowly added to the slurry. This concentrated malic acid and citric acid slurry completely hydrated at about 110° C., and the solution became transparent. Then, 150 g of glycerin and 90 g of monoglyceride were added to the clear malic acid and citric acid solution. Agitation was used to ensure uniform distribution of the monoglyceride in the solution.

Next, coated straws were made using a commercial straw extruder, manufactured by Norel (Sweden, model NX75-25D-50L), modified with a novel extrusion head and nozzle, which is described in U.S. Patent Application Publication No. 2003/0168772 by Palaniappan, et al. The molten malic acid and citric acid solution at about 110° C. was then pumped, using a precision gear pump, to the modified continuous straw extrusion head and nozzle with an acid solution flow rate of about 250 g/min. and an air flow rate of about 4 L/min. When the flow rate of the acid solution reached steady state, production of the acid coated straw was initiated. After about 100 minutes of continuous processing, a production rate of about 85,000 straws (based on the average straw length of 14 cm) per hour of the acid coated straw was achieved. The acid dosage loading per straw ranged from 170 to 400 milligrams. Approximately one hundred thousand acid coated straws were produced and packaged. Later, about five thousand of the packaged acid coated straws were each attached to a single serving beverage pouch containing Minute Maid® fruit punch.

### EXAMPLE 9

### Coating Straws with Composition Comprising Mixture of Malic Acid, Citric Acid, and Phosphoric Acid

Drinking straws were coated with a mixture of citric acid, malic acid, and phosphoric acid. A coating solution was prepared having the following formulation:

| Materials | Weight (g) | Percentage (%) |
|---|---|---|
| Malic acid anhydrous | 3212 g | 80.3% |
| Citric acid anhydrous | 400 g | 15.0% |
| Phosphoric acid (85 w/w %) | 235.3 g | 5.9% |
| Deionized (DI) water | 124.7 g | 3.1% |
| Glycerin (USP grade) | 20 g | 0.5% |
| Monoglyceride | 8 g | 0.2% |
| Total | 4000 g | 100.0% |

A 4 kg batch of molten mixed acid solution was prepared. First, 124.7 g of DI water and 400 g of citric acid anhydrous were added to a 3 L SS beaker, which was placed on the top of a hot plate. The citric acid slurry, while mixing with a tri-blade mixer, was heated to about 112° C. When the temperature of the citric acid solution reached about 112° C., the remaining malic acid solids, 3212 g, were slowly added to the slurry. This concentrated malic acid and citric acid slurry completely hydrated and melted at about 115° C., and the solution became transparent. Then, 235.3 g of 85% phosphoric acid, 20 g of glycerin, and 8 g of monoglyceride were added to the clear malic acid and citric acid solution. Agitation was used to ensure uniform distribution of the monoglyceride in the solution.

Next, the coated straws were made. One hundred straws with dimension of 15.9 cm in length and 0.4 cm in diameter were used to prepare citric/malic/phosphoric acid coated straws. Using the dip coating (at 112° C.), cooling, drying, and outer surface removal steps described in Example 1, the straws were provided with an opaque interior coating of malic acid/citric acid/phosphoric acid. The acid dosage loading per straw ranged from 150 to 550 milligrams.

A three-person taste panel was formed to evaluate the taste impact of the acid straws on the juice drinks of different flavors. The flavors evaluated were Fruit Punch and Clear Cherry. Conclusions from the taste panel were that an initial sour taste enhancement was observed through first several sips of juice drinks, the sour intensity peaked around the second to the third sips for most of the juice drinks, the sour impact tended to last five to ten sips ofjuice drinks, and the juice drink compositions and flavors played key roles in determining the detail taste impact of the acid straws. In general, the punch fruit flavors were found to go well with the acid straws.

From the above working examples, it was generally found that the use of mixtures of two or more of the food acids enhanced adhesion of the coating to the straws as compared to using a single acid composition, which appeared to chip or flake off from the straw more easily.

### EXAMPLE 10

### Coating Confectionery Articles with Malic Acid Composition

Confectionery articles were coated with a molten malic acid composition. A 1 kg batch of the coating composition, which comprised 100% malic acid anhydrous, was prepared as follows.

First, 100 g of malic acid anhydrous was added to a IL flat bottom glass beaker, which was placed on the top of a hot plate. The malic acid powder was gradually heated to about 140° C. When the temperature of the malic acid reached about 140° C., the malic acid powder melted into a clear liquid. The remaining malic acid, 900 g, was slowly added to the molten malic acid with appropriate agitation.

Next, various confectionery articles were coated with the molten malic acid. Several commercially available lollipops and hard candies were selected for use as confectionery substrates. These articles were dipped into the malic acid at about 135° C. and then cooled to ambient temperatures, to yield acid coated confectionery articles. The acid dosage loading per confectionery ranged from about 50 to about 10,000 milligrams.

The coating weight per article could be controlled by selection or adjustment of, for example, the surface area and the temperature of the substrate, or by repeating the coating process multiple times after the preceding coating layer(s) have been immobilized or solidified.

Publications cited herein and the materials for which they are cited are specifically incorporated by reference. Modifications and variations of the methods and devices described herein will be obvious to those skilled in the art from the foregoing detailed description. Such modifications and variations are intended to come within the scope of the appended claims.

We claim:

1. A method for producing an acid coated drinking straw or an acid coated confectionery article comprising the steps of:
(a) heating a food grade acid composition to a temperature sufficient for the acid composition to become fluid;
(b) applying the fluid acid composition from step (a) to a surface of a drinking straw or confectionery substrate; and
(c) cooling the acid composition coated drinking straw or acid coated confectionery substrate from step (b) to a temperature sufficient to immobilize the acid composition on the surface.

2. The method of claim 1, wherein the acid composition comprises a food grade acid selected from the group consisting of citric acid, adipic acid, fumaric acid, acetic acid, ascorbic acid, gluconolactone, phosphoric acid, hydrochloric acid, sulfuric acid, malic acid, tartaric acid, tannic acid, succinic acid, lactic acid, and mixtures thereof.

3. The method of claim 1, wherein the acid composition comprises a food grade acid selected from the group consisting of citric acid, phosphoric acid, malic acid, and mixtures thereof.

4. The method of claim 1, further comprising, prior to step (a), the step of preparing a food grade acid composition comprising about 40 to about 99.99 weight percent food grade acid, about 0.01 to about 5 weight percent surface tension reducing agent, 0 to about 30 weight percent plasticizer, 0 to about 20 weight percent bulk agent, and 0 to about 30 weight percent water.

5. The method of claim 4, wherein the acid composition comprises about 79 to about 99 weight percent food grade acid, about 0.01 to about 1 weight percent surface tension reducing agent, about 0.2 to about 5 weight percent plasticizer, and about 0.79 to about 15 weight percent water.

6. The method of claim 4, wherein the acid composition comprises about 88 to about 98 weight percent food grade acid, about 0.01 to about 0.5 weight percent surface tension reducing agent, about 0.2 to about 1 weight percent plasticizer, and about 1.79 to about 10.5 weight percent water.

7. The method of claim 4, wherein the food grade acid is selected from the group consisting of citric acid, adipic acid, fumaric acid, acetic acid, ascorbic acid, gluconolactone, phosphoric acid, hydrochloric acid, sulfuric acid, malic acid, tartaric acid, tannic acid, succinic acid, lactic acid, and mixtures thereof.

8. The method of claim 4, wherein the food grade acid is selected from the group consisting of citric acid, phosphoric acid, malic acid, and mixtures thereof.

9. The method of claim 4, wherein the surface tension reducing agent is a wetting agent, an emulsifier, or a surfactant.

10. The method of claim 4, wherein the surface tension reducing agent is selected from the group consisting of monoglycerides, diglycerides, acetylated monoglycerides, propylene glycol esters, lecithin, diacetyl tartaric acid esters of monoglycerides, glycerol esters, sodium dioctyl sulfosuccinate, polyglycerol esters, polysorbates, sodium stearoyl-2-lactylate, sorbitan esters, sugar esters, and mixtures thereof.

11. The method of claim 4, wherein the surface tension reducing agent comprises a monoglyceride.

12. The method of claim 4, wherein the plasticizer is selected from the group consisting of glycerin, sorbitol, propylene glycol, maltitol, mannitol, and mixtures thereof.

13. The method of claim 4, wherein the plasticizer comprises glycerin.

14. The method of claim 4, wherein the bulk agent is selected from the group consisting of cellulose fibers, hydrocolloids, low molecular weight carbohydrates, food grade colloidal silicas, and mixtures thereof.

15. The method of claim 1, further comprising, prior to step (a), the step of preparing a food grade acid composition comprising about 40 to 100 weight percent food grade acid, 0 to about 5 weight percent surface tension reducing agent, 0 to about 30 weight percent plasticizer, 0 to about 20 weight percent bulk agent, and 0 to about 30 weight percent water.

16. The method of claim 1, wherein the application of the fluid acid composition in step (b) occurs by co-extrusion during manufacture of the drinking straw.

17. The method of claim 1, wherein the application of the fluid acid composition in step (b) is by spraying the fluid acid composition onto the drinking straw or confectionery substrate.

18. The method of claim 1, wherein the application of the fluid acid composition in step (b) is by dipping the drinking straw or confectionery substrate into the fluid acid composition or by passing the drinking straw or confectionery substrate through a curtain coater.

19. The method of claim 1, wherein the steps are applied to a drinking straw.

20. The method of claim 19, wherein the surface of the drinking straw is the interior surface of the drinking straw.

21. The method of claim 19, wherein the acid coated drinking straw has an acid dosage loading of about 50 to about 5000 milligrams acid per straw.

22. The method of claim 19, wherein the acid dosage loading is from about 100 to about 1000 milligrams per straw.

23. The method of claim 19, wherein the acid dosage loading is from about 200 to about 700 milligrams per straw.

24. The method of claim 1, wherein the steps are applied to a confectionery substrate.

25. The method of claim 24, wherein the confectionery substrate is selected from the group consisting of candies, chewing gums, drink stirrers, spoons, tongue depressors, plastic structures, cereals, popcorn, fruits, and nuts.

26. The method of claim 1, further comprising applying a secondary coating onto the immobilized acid coating following step (c).

27. The method of claim 26, wherein the secondary coating is formed by contacting a powdered ingredient onto the surface of the immobilized acid coating.

28. The method of claim 27, wherein the powdered ingredient is selected from the group consisting of food acids, sugars, fizzing agents, colorants, probiotics, vitamins, herbs, and flavoring agents.

29. A method for producing an acid coated drinking straw having a surface comprising the steps of:
(a) preparing a food grade acid composition comprising about 88 to about 98 weight percent food grade acid, about 0.01 to about 0.5 weight percent surface tension reducing agent, about 0.2 to about 1 weight percent plasticizer, and about 1.79 to about 10.5 weight percent water;
(b) heating the acid composition to a temperature sufficient for the acid composition to become fluid;
(c) applying the fluid acid composition from step (b) to a surface of the drinking straw; and
(d) cooling the acid composition coated drinking straw from step (c) to a temperature sufficient to immobilize the acid composition on the surface.

30. The method of claim 29, wherein the acid coated drinking straw has an acid dosage loading of about 50 to about 5000 milligrams of food grade acid per straw.

31. The method of claim 29, wherein the food grade acid comprises a mixture comprising two or more of citric acid, phosphoric acid, or malic acid.

32. A method for forming a self-adherent acid coating on a substrate comprising the steps of:
(a) heating a composition which comprises a mixture of two or more food grade acids, to form a molten fluid acid mixture;
(b) applying a coating of the molten fluid acid mixture from step (a) onto a surface of a solid substrate; and
(c) cooling the coated substrate from step (c) to a temperature sufficient to immobilize the acid mixture on the surface of the solid substrate.

33. The method of claim 32, wherein the substrate in step (b) is a polymeric tube.

34. The method of claim 33, wherein application of the coating in step (b) is by spraying the molten fluid acid mixture onto the interior surface of the tube as the tube is extruded.

35. The method of claim 34, wherein the cooling in step (c) occurs by submerging the tube in cooling water.

36. The method of claim 34, wherein during or following step (c), the tube is stretched and cut into drinking straws.

37. The method of claim 32, wherein the substrate is selected from the group consisting of candies, chewing gums, drink stirrers, spoons, tongue depressors, plastic structures, cereals, popcorn, fruits, and nuts.

38. An acid coated article for imparting flavor to a user comprising:
a coating carrier comprising a drinking straw or a confectionery substrate; and
an immobilized food grade acid composition coated onto a surface of the coating carrier for imparting an acidic flavor,
wherein the acid composition coating is formed by heating the acid composition sufficient for the acid composition to become fluid, applying the fluid acid composition to the surface, and then cooling the acid composition sufficiently to immobilize the acid composition on the surface of the coating carrier.

39. The coated article of claim 38, wherein the acid composition comprises an acid selected from the group consisting of citric acid, adipic acid, acetic acid, ascorbic acid, fumaric acid, gluconolactone, phosphoric acid, hydrochloric acid, sulfuric acid, malic acid, tartaric acid, tannic acid, succinic acid, lactic acid, and mixtures thereof.

40. The coated article of claim 38, wherein the acid composition comprises an acid selected from the group consisting of citric acid, phosphoric acid, malic acid, and mixtures thereof.

41. The coated article of claim 38, wherein the coating carrier is drinking straw comprising an elongated drinking tube having an interior surface and an exterior surface and formed of a fluid impermeable material.

42. The coated article of claim 41, wherein the drinking straw has an acid dosage loading of about 50 to about 5000 milligrams acid per straw.

43. The coated article of claim 41, wherein the drinking straw has an acid dosage loading is from about 100 to about 1000 milligrams per straw.

44. The coated article of claim 41, wherein the drinking straw has an acid dosage loading is from about 200 to about 700 milligrams per straw.

45. The coated article of claim 41, wherein the interior surface of the drinking tube is coated with the acid composition.

46. The coated article of claim 38, wherein the acid composition comprises about 40 to about 99.99 weight percent food grade acid, about 0.01 to about 5 weight percent surface tension reducing agent, 0 to about 30 weight percent plasticizer, 0 to about 20 weight percent bulk agent, and 0 to about 30 weight percent water.

47. The coated article of claim 46, wherein the food grade acid is selected from the group consisting of citric acid, adipic acid, acetic acid, ascorbic acid, fumaric acid, gluconolactone, phosphoric acid, hydrochloric acid, sulfuric acid, malic acid, tartaric acid, tannic acid, succinic acid, lactic acid, and mixtures thereof.

48. The coated article of claim 46, wherein food grade acid is selected from the group consisting of citric acid, phosphoric acid, malic acid and mixtures thereof.

49. The coated article of claim 46, wherein the surface tension reducing agent is a wetting agent, an emulsifier, or a surfactant.

50. The coated article of claim 46, wherein the surface tension reducing agent is selected from the group consisting of monoglycerides, diglycerides, acetylated monoglycerides, propylene glycol esters, lecithin, diacetyl tartaric acid esters of monoglycerides, glycerol esters, sodium dioctyl sulfosuccinate, polyglycerol esters, polysorbates, sodium stearoyl-2-lactylate, sorbitan esters, sugar esters, and mixtures thereof.

51. The coated article of claim 46, wherein the surface tension reducing agent comprises monoglyceride.

52. The coated article of claim 46, wherein the plasticizer is selected from the group consisting of glycerin, sorbitol, propylene glycol, maltitol, mannitol, and mixtures thereof.

53. The coated article of claim 46, wherein the plasticizer comprises glycerin.

54. The coated article of claim 46, wherein the bulk agent is selected from the group consisting of cellulose fibers, hydrocolloids, low molecular weight carbohydrates, food grade colloidal silicas, and mixtures thereof.

55. The coated article of claim 38, wherein the acid composition comprises about 79 to about 99 weight percent food grade acid, about 0.01 to about 1 weight percent surface tension reducing agent, about 0.2 to about 5 weight percent plasticizer, and about 0.79 to about 15 weight percent water.

56. The coated article of claim 55, wherein food grade acid is selected from the group consisting of citric acid, phosphoric acid, malic acid, and mixtures thereof.

57. The coated article of claim 55, wherein the surface tension reducing agent is selected from the group consisting of monoglycerides, diglycerides, acetylated monoglycerides, propylene glycol esters, lecithin, diacetyl tartaric acid esters of monoglycerides, glycerol esters, sodium dioctyl sulfosuccinate, polyglycerol esters, polysorbates, sodium stearoyl-2-lactylate, sorbitan esters, sugar esters, and mixtures thereof.

58. The coated article of claim 55, wherein the plasticizer is selected from the group consisting of glycerin, sorbitol, propylene glycol, maltitol, mannitol, and mixtures thereof.

59. The coated article of claim 35, wherein the acid composition comprises about 88 to about 98 weight percent food grade acid, about 0.01 to about 0.5 weight percent surface tension reducing agent, about 0.2 to about 1 weight percent plasticizer, and about 1.79 to about 10.5 weight percent water.

60. The coated article of claim 59, wherein food grade acid is selected from the group consisting of citric acid, phosphoric acid, malic acid, and mixtures thereof.

61. The coated article of claim 59, wherein the surface tension reducing agent is selected from the group consisting of monoglycerides, diglycerides, acetylated monoglycerides, propylene glycol esters, lecithin, diacetyl tartaric acid esters of monoglycerides, glycerol esters, sodium dioctyl sulfosuccinate, polyglycerol esters, polysorbates, sodium stearoyl-2-lactylate, sorbitan esters, sugar esters, and mixtures thereof, and wherein the plasticizer is selected from the group consisting of glycerin, sorbitol, propylene glycol, maltitol, mannitol, and mixtures thereof.

62. The coated article of claim 38, wherein the food grade acid composition comprises about 40 to 100 weight percent food grade acid, 0 to about 5 weight percent surface tension reducing agent, 0 to about 30 weight percent plasticizer, 0 to about 20 weight percent bulk agent, and 0 to about 30 weight percent water.

63. The coated article of claim 38, wherein the coating carrier is a confectionery substrate.

64. The coated article of claim 63, wherein the confectionery substrate is selected from the group consisting of candies, chewing gums, drink stirrers, spoons, tongue depressors, plastic structures, cereals, popcorn, fruits, and nuts.

65. The coated article of claim 38, further comprising a secondary coating which is coated onto the food acid composition coating.

66. The coated article of claim 65, wherein the secondary coating comprises a powdered ingredient adhered onto the surface of the food acid composition coating.

67. The coated article of claim 66, wherein the powdered ingredient is selected from the group consisting of food acids, sugars, fizzing agents, colorants, probiotics, vitamins, herbs, and flavoring agents.

68. An acid coated drinking straw comprising:
an elongated drinking tube having an interior surface and an exterior surface and formed of a fluid impermeable material; and
a food grade acid composition coated on at least one of the surfaces for imparting an acidic flavor,
wherein the acid composition comprises about 88 to about 98 weight percent food grade acid, about 0.01 to about 0.5 weight percent surface tension reducing agent, about 0.2 to about 1 weight percent plasticizer, and about 1.79 to about 10.5 weight percent water.

69. The acid coated drinking straw of claim 68, wherein the acid composition coating is applied by heating an acid composition to a temperature sufficient for the acid composition to be fluid, applying the fluid acid composition onto the at least one of the surfaces, and then cooling the composition to immobilize the acid composition on the at least one of the surfaces, thereby forming the coating which self-adheres to the at least one of the surface of the drinking straw.

70. The acid coated drinking straw of claim 68, which has an acid dosage loading of about 50 to about 5000 milligrams acid per straw.

71. The acid coated drinking straw of claim 68, wherein the food grade acid comprises a mixture comprising two or more of citric acid, phosphoric acid, or malic acid.

72. An acid coated drinking straw comprising:
an elongated drinking tube having an interior surface and formed of a fluid impermeable material; and
a food grade acid composition coated on the interior surface,
wherein the acid composition comprises about 88 to about 98 weight percent food grade acid selected from the group consisting of citric acid, adipic acid, acetic acid, ascorbic acid, fumaric acid, gluconolactone, phosphoric acid, hydrochloric acid, sulfuiric acid, malic acid, tartaric acid, tannic acid, succinic acid, lactic acid and mixtures thereof; about 0.01 to about 0.5 weight percent surface tension reducing agent selected from the group consisting of monoglycerides, diglycerides, acetylated monoglycerides, propylene glycol esters, lecithin, diacetyl tartaric acid esters of monoglycerides, glycerol esters, sodium dioctyl sulfosuccinate, polyglycerol esters, polysorbates, sodium stearoyl-2-lactylate, sorbitan esters, sugar esters and mixtures thereof; about 0.2 to about 1 weight percent plasticizer selected from the group consisting of glycerin, sorbitol, propylene glycol, maltitol, mannitol and mixtures thereof; and
about 1.79 to about 10.5 weight percent water.

73. The acid coated drinking straw of claim 72, wherein the food grade acid is selected from citric acid, phosphoric acid, malic acid and mixtures thereof;
the surface tension reducing agent is monoglyceride; and the plasticizer is glycerin.

74. The acid coated drinking straw of claim 72, which has an acid dosage loading of about 50 to about 5000 milligrams acid per straw.

75. A beverage kit of parts comprising:
a container comprising beverage; and
at least one acid coated drinking straw suitable for insertion into the container and for imparting an acid flavor to the beverage when drinking the beverage through the straw, wherein the drinking straw comprises a food grade acid composition coated on the interior surface of the drinking straw.

76. The beverage kit of claim 75, wherein the beverage comprises a fruit juice or fruit flavored drink.
